(19) United States
(12) Patent Application Publication
(10) Pub. No.: US 2006/0097481 A1
(43) Pub. Date: May 11, 2006

(54) Trailer hitch alignment device

(76) Inventor: Larry E. Nicholas, Bluffton, SC (US)

Correspondence Address: WELSH & FLAXMAN LLC, 2000 DUKE STREET, SUITE 100, ALEXANDRIA, VA, 22314, US

(21) Appl. No.: 11/265,504

(22) Filed: Nov. 3, 2005

Related U.S. Application Data
(60) Provisional application No. 60/624,184, filed on Nov. 3, 2004.

(51) Int. Cl. B60D 1/36

(52) U.S. Cl. 280/477

(57) ABSTRACT

A trailer hitch alignment device including a first swivel joint adapted to be secured to a trailer and a height adjustment bar having a first end and a second opposite end wherein the first end is mounted to the first swivel joint and a second swivel joint mounted on the second opposite end of the height adjustment bar. The height adjustment bar supports a switching unit connected to the second swivel joint. The switching unit includes a switch connected between and extending vertically above the switching unit and an adjustable length activation rod extending horizontally forward from the switching unit which is adapted to contact a towing vehicle to activate the switch. A power source is connected to the switch and a stoplight via an electrical circuit such that the adjustable length activation rod contacts a towing vehicle when the vehicle backs up into proper position and moves the activation rod in order to activate the switch and complete the circuit between the stoplight and power source thereby illuminating the stoplight to provide a visual indication to the towing vehicle driver.

### BACKGROUND OF THE INVENTION

1. Field of the Invention

The invention relates to a trailer hitch alignment device. More particularly, the invention relates to a trailer hitch alignment device employing a stoplight which is actuated when the hitch ball on the vehicle is aligned with the trailer tongue.

2. Background of the Invention

The use of trailer hitch alignment systems is well known in the prior art and there have been numerous previous attempts in assisting drivers align their vehicle for hitch attachment. Some prior attempts have been quite simple, while others are quite complex. While these devices fulfill their respective, particular objectives and requirements, the prior art hitch alignment systems do not disclose the new and inventive trailer hitch alignment device of the present invention.

### SUMMARY OF THE INVENTION

The present invention provides a trailer hitch alignment device including a first swivel joint adapted to be secured to a trailer. The device also includes a height adjustment bar having a first end and a second opposite end, wherein the first end is mounted to the first swivel joint, a second swivel joint is mounted on the second opposite end of the height adjustment bar and a switching unit is connected to the second swivel joint. The switching unit includes a switch connected between a stoplight extending vertically above the switching unit and an adjustable length activation rod extending horizontally from the switching unit adapted to contact a towing vehicle. A power source is connected to the switch and stoplight via an electrical circuit, wherein when the adjustable length activation rod contacts a towing vehicle as it moves to activate the switch and complete the circuit between the stoplight and power source. This illuminates the stoplight to provide a visual indication to the towing vehicle driver.

It is also an object of the invention to provide a trailer hitch alignment device wherein the length of the height adjustment bar is variable.

It is a further object of the invention to provide a trailer hitch alignment device wherein the adjustable length activation rod is formed from a pair of telescoping rods which can be locked in place relative to one another.

Still a further object of the invention is to provide a trailer hitch alignment device wherein the power source is a battery.

Yet another object of the invention is to provide a trailer hitch alignment device wherein the stoplight is mounted above the switching unit, approximately at the height of the towing vehicle's rear window by a hollow light bar.

Yet still another object of the invention is to provide a trailer hitch alignment device wherein the switch includes a spring biased lever which moves against the bias when contacted by the adjustable length activation rod.

Another object of the invention is to provide a trailer hitch alignment device wherein the height adjustment bar, the second swivel joint, the switching unit and power source are removable from the first swivel joint as a single unit for storage when not in use.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the present trailer hitch alignment device in operation.

FIG. 2 shows a disassembled view of the component parts that make up the present trailer hitch alignment device.

FIG. 3 shows an assembled trailer hitch alignment device in its highest adjusted position.

FIG. 4 shows an assembled trailer hitch alignment device in an adjusted height and forward position.

FIG. 5 shows an assembled trailer hitch alignment device in an adjusted height and aft position.

FIG. 6 shows in a flow chart manner the steps involved with installing and using the trailer hitch alignment device for aiding in hitching up a trailer to a towing vehicle.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for teaching one skilled in the art how to make and/or use the invention.

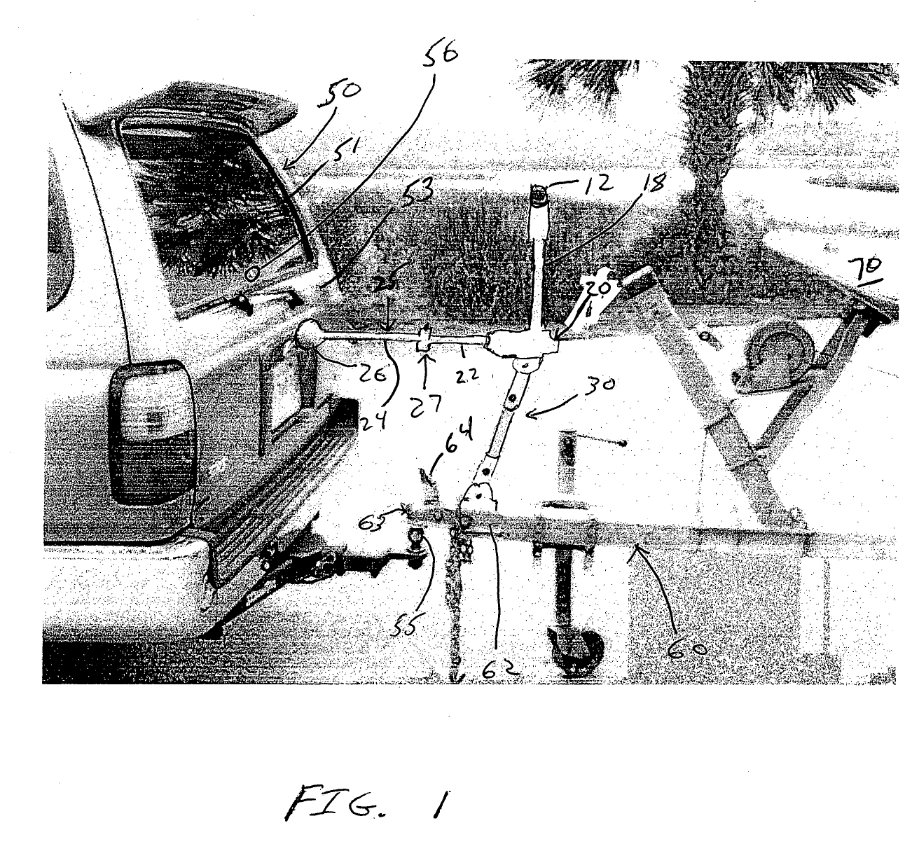

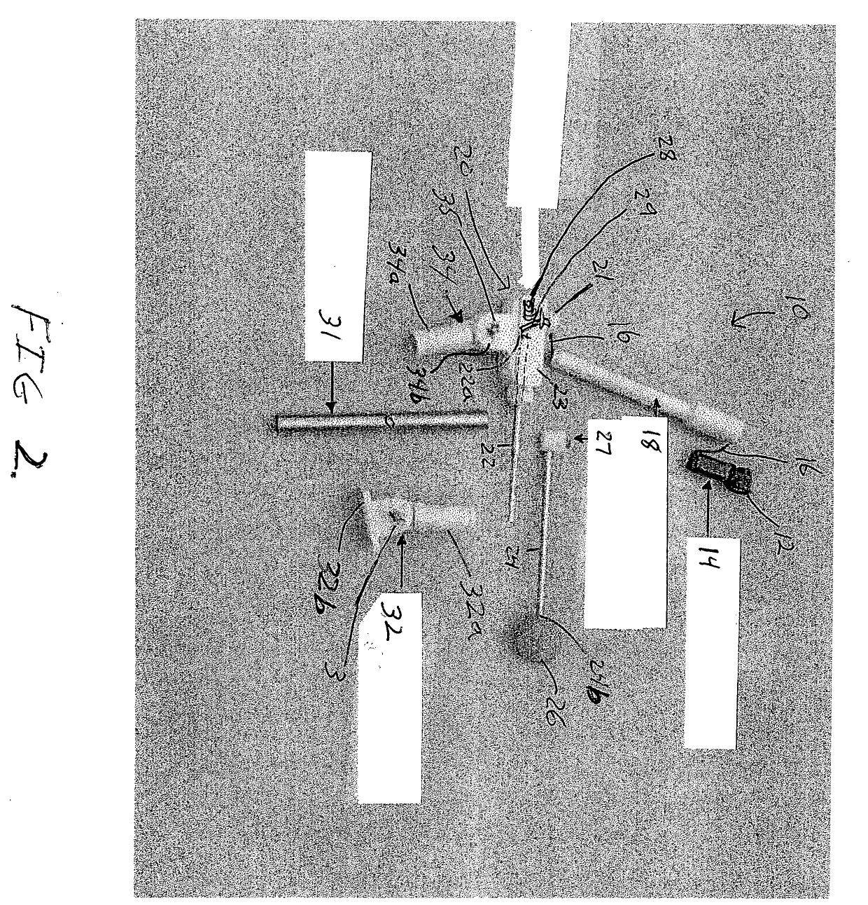

With reference to the FIGS. 1, 2, 3, 4 and 5, a trailer hitch alignment device 10 mountable to a trailer 60 is disclosed. Generally, the trailer hitch alignment device 10 includes a stoplight 12 operated by a battery 14. The stoplight 12 is preferably a high output LED which operates on low voltage. The stoplight 12 is mounted on a hollow light bar 18 so as to be visible through the rear window of a vehicle 50 upon which a hitch ball 55 is mounted. The stoplight 12 is actuated by a switch 21 when the hitch ball 55 on the vehicle 50 is aligned with the hitch ball receiver 63 on the tongue 62 of the trailer 60 and an adjustable length activation rod 25 makes contact with the vehicle 50.

The switch 21, stoplight 12 and adjustable length activation rod 25 form a switching unit 20 that is mounted on a height adjustment bar assembly 30. The height adjustment bar assembly 30 includes a lower swivel mount 32, a height adjustment bar 31 and an upper swivel mount 34.

More specifically, the height adjustment bar assembly 30 includes a height adjustment bar 31 that may be telescopically adjustable in length or may be simply cut to a desired length. Located at the lower end of the height adjustment bar 31 is a lower swivel mount 32. The lower swivel mount 32 includes a base 32b, a pivotal arm 32a and a wing nut assembly 33. The wing nut assembly 33 secures the base 32b to the pivotal arm 32a such that the pivotal arm 32a can be locked in various orientations with regard to the base 32b. The base 32b of the lower swivel mount 32 is secured to the tongue 62 of a trailer 60 upon which a boat 70 or other object may be loaded.

Located at the upper end of the height adjustment bar 31 is an upper swivel mount 34. The upper swivel mount 34 includes a base 34b, a pivotal arm 34a and a wing nut assembly 35. The wing nut assembly 35 secures the base 34b to the pivotal arm 34a such that the pivotal arm 34a can be locked in various orientations with regard to the base 34b. The base 34b of the upper swivel mount 34 is secured to the switching unit 20.

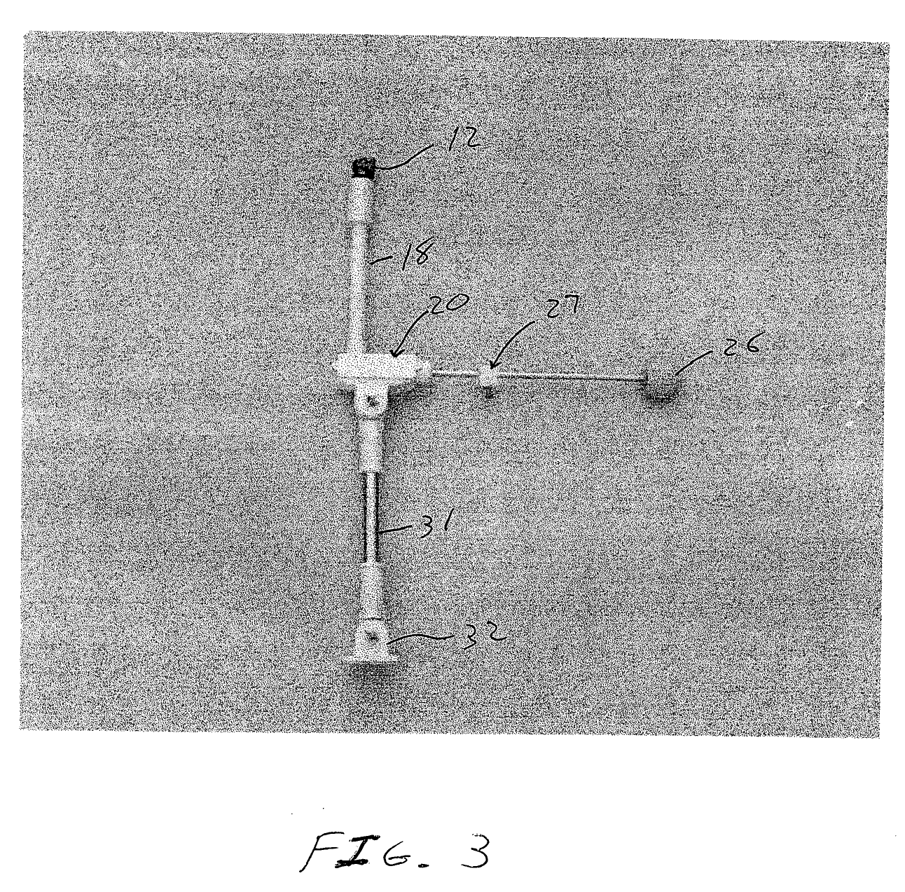

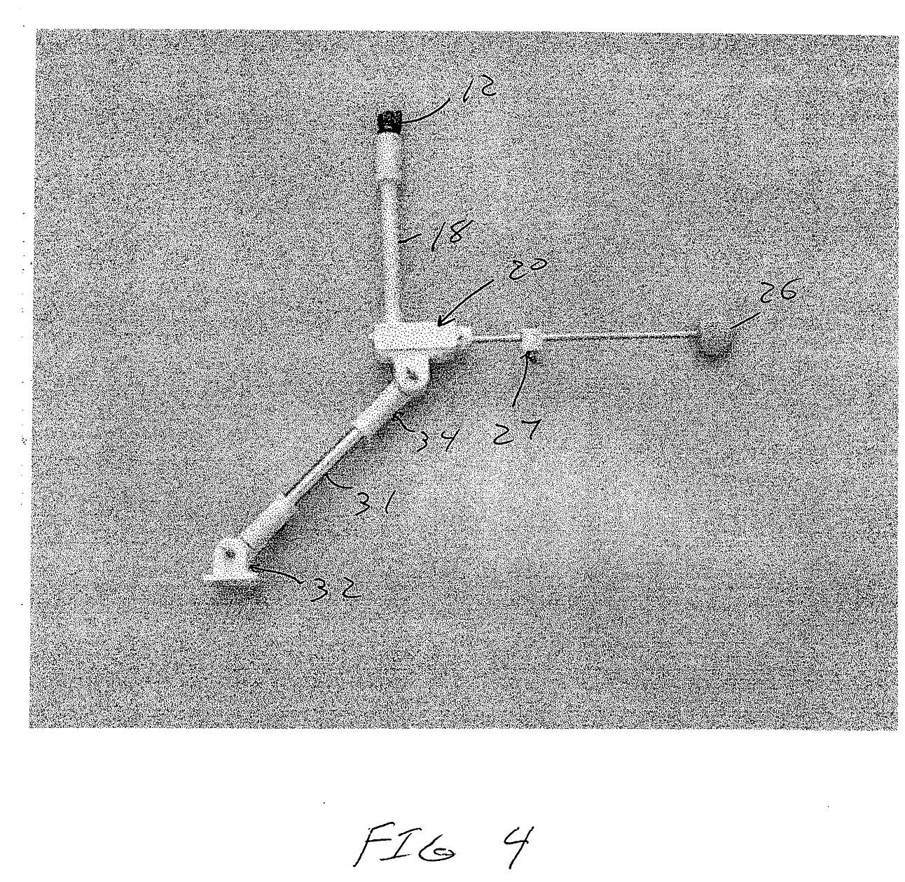

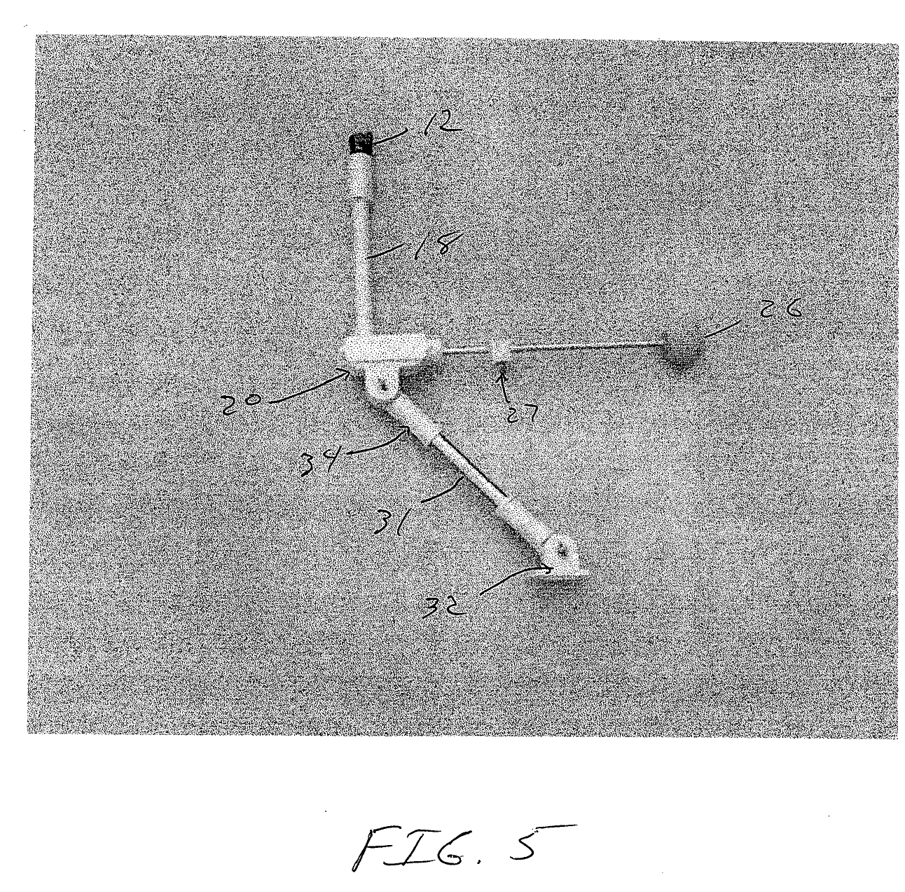

As can be seen in FIGS. 3, 4 and 5, the height adjustment bar assembly 30 allows the switching unit 20 to be positioned at various heights, as well as forward and aft positions, with regard to the hitch ball receiver 63 of trailer tongue 62. Referring to FIG. 3, the pivotal arms 32a, 34a of the swivel mounts 32, 34 are locked at 180 degrees relative to the bases 32b, 34b and provide the maximum height attainable. Referring to FIG. 4, the arms 32a, 34a of the swivel mounts 32, 34 are locked at 45 degrees relative to the bases 32b, 34b and provide one of the many forward and height positions attainable. With reference to FIG. 5, the arms 32a, 34a of the swivel mounts 32, 34 are locked at 45 degrees relative to the bases 32b, 34b and provide one of the many aft and height positions attainable.

As previously discussed, the adjustable height bar assembly 30 is secured to the switching unit 20 via the base 34b of the upper swivel mount 34. The switching unit 20 is formed of a switch 21 located within a housing 23, a hollow light bar 18 extends vertically upward from the housing 23, a stoplight 12 located on the upwardly extending light bar 18 and an adjustable length activation rod 25.

More specifically, the adjustable length activation rod 25 is formed from an inner telescoping rod 22 and an outer telescoping rod 24 which are secured together by a threaded screw 27. The adjustable length light activation rod 25 extends horizontally and transversely to the light bar 18. It has a first end 22a which slides within the housing 23 to make contact with, and activate, the switch 21 and a second end 24b which includes a soft vehicle contacting object 26, such as a tennis ball or rubber ball. The telescoping rods 22, 24 of the adjustable length activation rod 25 slide apart and together to adjust in length, and are locked in a selected length by a threaded screw 27 traveling through the outer rod 24 into contact with the inner rod 22. As those skilled in the art will certainly appreciate, other methods of locking telescopic rods are well known and may be used without departing from the spirit of the present invention. One such method contemplated is wherein the rods are twisted relative to one another and an eccentric cam located on the inner rod, and within the outer rod, rotates and locks the cam against the inner surface of the outer rod.

The stoplight 12 located on the light bar 18 is powered by a replaceable battery or batteries 14, which are stored within the hollow light bar 18 when the switching unit 20 is assembled. Further, wires 16 run through the light bar 18 and connect the switch 21, the battery 14 and the stoplight 12 to form an open electrical circuit that closes when the switch 21 is activated by the adjustable length activation rod 25.

As those skilled in the art will certainly appreciate, the switch 21 may take a variety of forms. However, and in accordance with a preferred embodiment of the present invention, the switch 21 includes a lever 29 which is spring biased in an open position and is closed when the adjustable length activation rod 25 moves horizontally and contacts the lever 29 to overcome the bias of the spring 28.

As will be appreciated based upon the following discussion, the present trailer hitch alignment device 10 is highly adjustable for accommodating various vehicle sizes and trailers. In particular, the height adjustment bar assembly 30 includes two pivot points linking the height bar 31 to the switching unit 20. As such, the trailer hitch alignment device 10 may be pivoted in a variety of orientations allowing for proper calibration of the device 10 as discussed herein in greater detail.

The various components forming the trailer hitch alignment device 10 are made from non-corrosive materials, such a plastic and aluminum.

In practice, the present trailer hitch alignment device 10 is mounted and calibrated upon the trailer tongue 62 for a particular vehicle 50 in the following manner. First, the center of the rear glass of a vehicle 50 or the center of the tailgate on a pick-up truck is identified and a center marker 56 is positioned thereon. The center marker 56 may simply be a removable sticker. The trailer 60 is then mounted upon the hitch ball 55 of the vehicle 50 and the hitch ball receiver 63 of the trailer tongue 62 is raised one inch above the hitch ball 55.

Thereafter, the trailer hitch alignment device 10 is oriented such that the stoplight 12 is clearly visible from within the vehicle 60 and the adjustable length activation rod 25 is adjusted to extend and touch the back of the vehicle 50 with the activation rod 25 being level and activating the switch 21. Those skilled in the art will understand that, depending upon the trailer height, the height adjustment bar assembly 30 may need to be pivoted via the upper and lower swivel mounts 32, 34 so as to properly orient the switching unit 20 to accommodate different vehicle heights. Once the activation rod 25 is level and activating the switch 21, the stoplight 12 on and clearly visible, holes within the base 32b are marked on the trailer tongue 62. The holes are then drilled and the lower swivel base 32b is rigidly coupled to the trailer tongue 62 via various fasteners, such as weather resistant screws or bolts. Now the device is ready for use.

Once the trailer hitch alignment device 10 is properly secured to the trailer tongue 62 and the adjustable length activation rod 25 is properly adjusted to activate the switch 21 when contact is made with the vehicle 50, one may readily bring the vehicle 50 into proper orientation for mounting the hitch ball receiver 63 of the trailer tongue 62 upon hitch ball 55. In particular, the vehicle 50 is pulled forward of the trailer tongue 62 and backed up, slowly aligning the center marker 56 with the stoplight 12 or the light bar 18. The driver will continue moving backward until the stoplight 12 at the top of the light bar 18 comes on. This indicates the rear of the vehicle 50 has contacted the soft object 26 at the second end 24b of the activation rod 25, moving the light activation rod 25 horizontally into contact with and overcoming the spring bias of the switch 21.

When this movement occurs, the switch 21 is actuated to activate the stoplight 12. This will indicate that the hitch ball 55 and the hitch ball receiver 63 of the trailer tongue 62 are aligned. Thereafter, the driver places the vehicle 50 in park and lowers the hitch ball receiver 63 of the trailer tongue 62 upon the hitch ball 55. Before the trailer 60 can be towed, the hitch ball receiver 63 is locked in place on the hitch ball 55, safety chains 58 are attached and the adjustable length activation rod 25 is telescopically shortened so that it is no longer in contact with the vehicle.

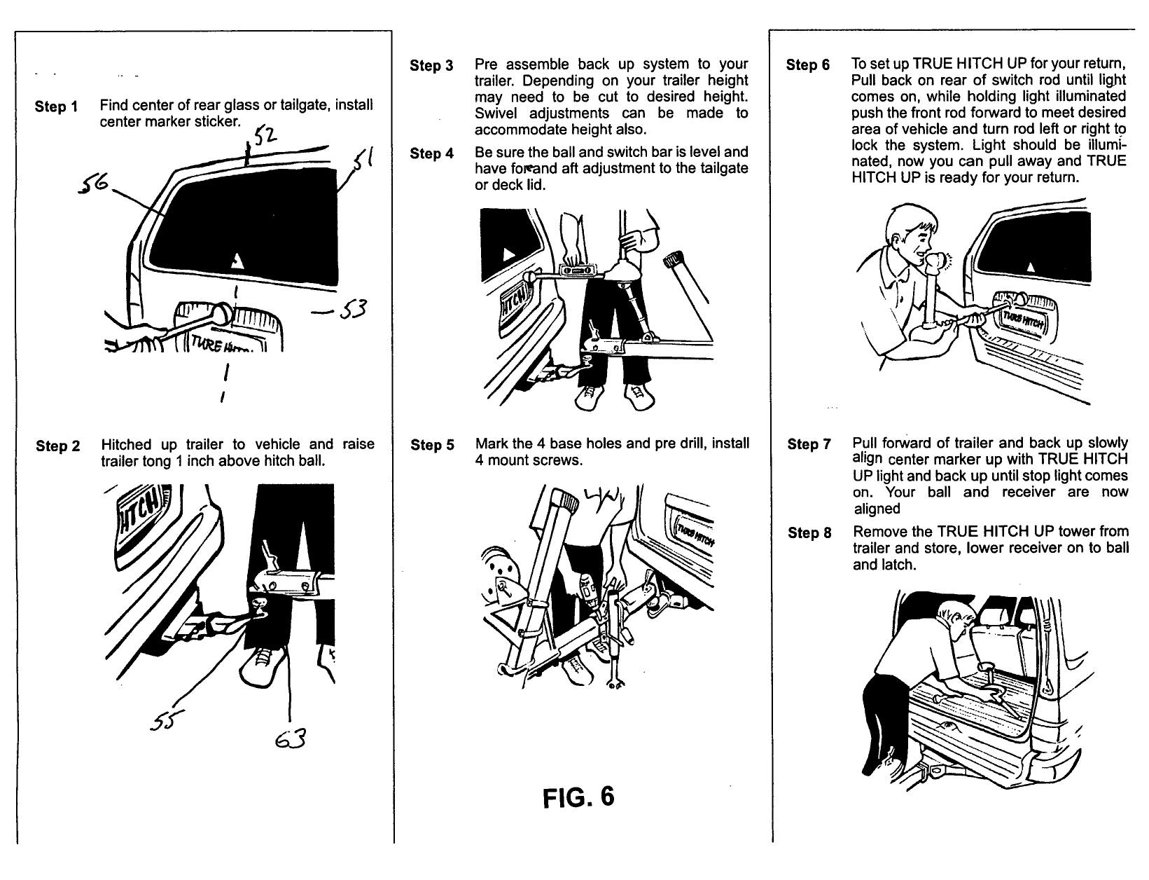

Referring to FIG. 6, the installation steps and operation of the trailer hitch alignment device 10 are illustrated and described in a flow chart manner. Step 1, find the center of the rear window 51 or tailgate as long as it is visible through the rear window and install a center marker sticker 56 thereon (the center of the window should align with the center of the hitch ball.). Step 2, hitch up the trailer 60 to the towing vehicle's hitch ball 55 and then raise the trailer tongue 62 such that the hitch ball receiver 63 is about 1 inch above the hitch ball 55. Step 3, remove the trailer hitch alignment device 10 from the packaging and assemble to form a complete unit as shown in FIG. 3. Thereafter, depending upon the trailer height, the height bar 31 and swivels 32, 34 are adjusted to assure that the activation rod 25 contacts the towing vehicle at a desired center line 52 location and that the stoplight 12 is visible through the rear window 51. Step 4, level the activation rod 25 and adjust the unit fore and aft so that the end 26 of the activation rod 25 contacts the towing vehicle. Step 5, mark and drill four mounting holes into the trailer tongue 62 assuring the stoplight is visible through the rear window 51 and that the end 26 of the activation rod 25 is in contact with the center line 52 on the towing vehicle and secure the swivel 32 via screws to the tongue 62. Step 6, set up the trailer hitch alignment unit after launching a boat off the trailer by pulling back on the rear half or inner telescoping rod 22 of the activation rod 25 to illuminate the stoplight 12 while moving the front half or outer telescoping rod 24 forward into contact with the towing vehicle 50 and locking the front and rear rods together. Thereafter, the vehicle is pulled forward and the stoplight 12 will go out. Step 7, to use the device 10 for hitching a trailer to the vehicle, pull the vehicle forward of the trailer and back up slowly aligning the center sticker marker 56 up with the stoplight 12 and until the stoplight 12 illuminates. The hitch ball 55 and the hitch ball receiver 63 are now aligned. Step 8, lift the trailer hitch alignment device 10 from the swivel 32 and store it in the vehicle, then lower the hitch receiver 63 onto the hitch ball 55 and operate the latch 64 to lock trailer to vehicle.

While various preferred embodiments have been shown and described, it will be understood that there is no intent to limit the invention by such disclosure, but rather, is intended to cover all modifications and alternate constructions falling within the spirit and scope of the invention.

1. A trailer hitch alignment device comprising:
a first swivel joint adapted to be secured to a trailer;
a height adjustment bar having a first end and a second opposite end wherein the first end is mounted to the first swivel joint;
a second swivel joint mounted on the second opposite end of the height adjustment bar;
a switching unit connected to the second swivel joint, the switching unit including a switch connected between a stoplight extending vertically above the switching unit and an adjustable length activation rod extending horizontally forward from the switching unit, adapted to contact a towing vehicle to activate the switch;
a power source connected to the switch and the stoplight via an electrical circuit; wherein when the adjustable length activation rod contacts a towing vehicle it moves to activate the switch and complete a circuit between the stoplight and a power source thereby illuminating the stoplight to provide a visual indication to the towing vehicle driver.

2. The trailer hitch alignment device of claim 1, wherein a length of the height adjustment bar is variable.

3. The trailer hitch alignment device of claim 1, wherein the adjustable length activation rod is formed from a pair of telescoping rods which can be locked in place relative to one another.

4. The trailer hitch alignment device of claim 1, wherein the power source is a battery.

5. The trailer hitch alignment device of claim 1, wherein the stoplight is mounted above the switching unit, approximate the height of the towing vehicle's rear window by a hollow light bar.

6. The trailer hitch alignment device of claim 1, wherein the switch includes a spring biased lever which moves against bias when contacted by the adjustable length activation rod.

7. The trailer hitch alignment device of claim 1, wherein the height adjustment bar, the second swivel joint, the switching unit and the power source are removable from the first swivel joint as a single unit for storage when not in use.

8. A trailer hitch alignment device comprising:
a first swivel joint adapted to be secured to a trailer;
a height adjustment bar having a first end and a second opposite end wherein the first end is mounted to the first swivel joint;
a second swivel joint mounted on the second opposite end of the height adjustment bar;
a switching unit connected to the second swivel joint, the switching unit including a switch connected between a stoplight extending vertically above the switching unit and an adjustable length activation rod extending horizontally forward from the switching unit, adapted to contact a towing vehicle to activate the switch;
a power source connected to the switch and the stoplight via an electrical circuit; wherein when the adjustable length activation rod contacts a towing vehicle it moves to activate the switch and complete a circuit between the stoplight and a power source thereby illuminating the stoplight to provide a visual indication to the towing vehicle driver; and
wherein the height adjustment bar, the second swivel joint, the switching unit and the power source are removable from the first swivel joint as a single unit for storage when not in use.

9. The trailer hitch alignment device of claim 8, wherein a length of the height adjustment bar is variable.

10. The trailer hitch alignment device of claim 8, wherein the adjustable length activation rod is formed from a pair of telescoping rods which can be locked in place relative to one another.

11. The trailer hitch alignment device of claim 8, wherein the power source is a battery.

12. The trailer hitch alignment device of claim 8, wherein the stoplight is mounted above the switching unit, approximate the height of the towing vehicle's rear window by a hollow light bar.

13. The trailer hitch alignment device of claim 8, wherein the switch includes a spring biased lever which moves against bias when contacted by the adjustable length activation rod.
